(19) United States
(12) Patent Application Publication
(10) Pub. No.: US 2010/0059156 A1
(43) Pub. Date: Mar. 11, 2010

(54) PNEUMATIC TIRE

(76) Inventors: Anne-France Gabrielle Jeanne-Marie Cambron, Mersch (LU); Michel Jean Yves Windeshausen, Messancy (BE); Jean Luc Dheur, Arlon (BE); Gia Van Nguyen, Hochiminh Ville (VN); Alain Emile Francois Roesgen, Asselborn (LU); Jean-Marc Lacaze, Niederfeulen (LU); Peter Phelps Roch, Luxembourg (LU); Andrew Frederick Weimer, Akron, OH (US); Ghislain Adolphe Leon Thise, Bastrogne (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/557,914

(22) Filed: Sep. 11, 2009

Related U.S. Application Data
(60) Provisional application No. 61/096,303, filed on Sep. 11, 2008.

(51) Int. Cl. B60C 1/00

(52) U.S. Cl. 152/209.5

(57) ABSTRACT

A pneumatic tire having a tire tread, the tread comprising grooves therein, the grooves forming tread elements, the tread having a radially outer surface and a non-skid tread depth as measured from the radially outer surface of the tread, and a radially innermost surface of the grooves, and one or more sunken grooves located radially inward and below the surface of the unworn tread, the tread comprised of a base tread compound, a radially outer compound, and a radially inner compound, wherein the intersection of the radially outer compound and the radially inner compound is wavy.

This application claims the benefit of and incorporates by reference U.S. Provisional Application No. 61/096,303 filed Sep. 11, 2008.

### FIELD OF THE INVENTION

The present invention is directed to a pneumatic tire. More particularly, the invention is directed to an evolving tread pattern and rubber composition that change as the tire wears in order to maintain performance.

### BACKGROUND OF THE INVENTION

As a tire wears, the volume of the tread decreases due to frictional contact with the road surface. As the tire wears, the volume of the grooves decrease, as the non-skid decreases. Eventually the tire will require replacement.

When the groove volume decreases, it reduces the tire's ability to channel water away from the tire footprint, reducing wet road tire performance. For some tread configurations, even if the tire tread has not worn down to the legal minimum non-skid depth, the tire's wet road performance may be severely limited.

As the tire wears, dry braking performance generally improves while wet braking performance may degrade.

It is thus desired to provide a tire having excellent handling and performance characteristics when new, and maintain an acceptable tire performance during its life.

### SUMMARY OF THE INVENTION

Disclosed herein is a tire tread designed to have a variable tread pattern and rubber composition. The tread pattern and the rubber composition change with wear to achieve similar tread performance for the tire when both new and worn. The changing pattern and compound optimize the worn tire performance in an attempt to maintain the tire's wet performance characteristics.

### DEFINITIONS

“Blade” means a protrusion in a tire curing mold that forms part of the tread design. The protrusion forms a corresponding depression in the finished tire tread.

“Groove” means an elongated void area in a tread that may extend circumferentially or laterally about the tread in a straight curved, or zigzag manner. Circumferentially and laterally extending grooves sometimes have common portions and may be sub classified as “wide” or “narrow.” A “narrow groove” has a width greater than a sipe, but less than or equal to about 4.0 mm and a “wide groove” has a width greater than about 4.0 mm. The groove width is equal to tread surface area occupied by a groove or groove portion, divided by the length of such groove or groove portion; thus, the groove width is its average width over its length.

“Radial” and “radially” are used to mean directions radially toward or away from the axis of rotation of the tire.

“Rib” means a circumferentially extending strip of rubber of the tread which is defined by at least one circumferential groove and either a second circumferential groove or a lateral edge, wherein the strip is not divided by full depth grooves.

“Sipes” refer to very narrow width grooves molded into tread elements of a tire that subdivide the tread elements. Sipes have a width in the range of about 0.3 mm to about 1.0 mm. The width of a sipe is such that the sipe tends to close completely in a tire footprint.

### BRIEF DESCRIPTION OF THE DRAWINGS

The invention will be described by way of example and with reference to the accompanying drawings in which:

FIG. 1 is a perspective view of a first embodiment of a tire of the present invention;

FIG. 2 is a front view of the tire of FIG. 1;

FIG. 3 is a close up front view of the tire tread of FIG. 2; and

FIGS. 4A and 4B are partial cross-sectional views of a green tire tread section after extrusion and a corresponding cured section of the tire tread;

FIGS. 5A-5C illustrate additional partial cross-sectional views of additional embodiments of a green tire tread section after extrusion;

FIG. 6 is a perspective view of a keyhole sipe blade;

FIG. 7 is a perspective view of a blade for forming a sunk groove;

FIGS. 8-11 illustrate a tire tread showing varying degrees of wear;

FIG. 12 illustrates the tire shown in FIG. 1 when the tread is worn; and

FIG. 13 illustrates a tire footprint with a worn tread, illustrating the water evacuation pathways.

### DETAILED DESCRIPTION OF THE INVENTION

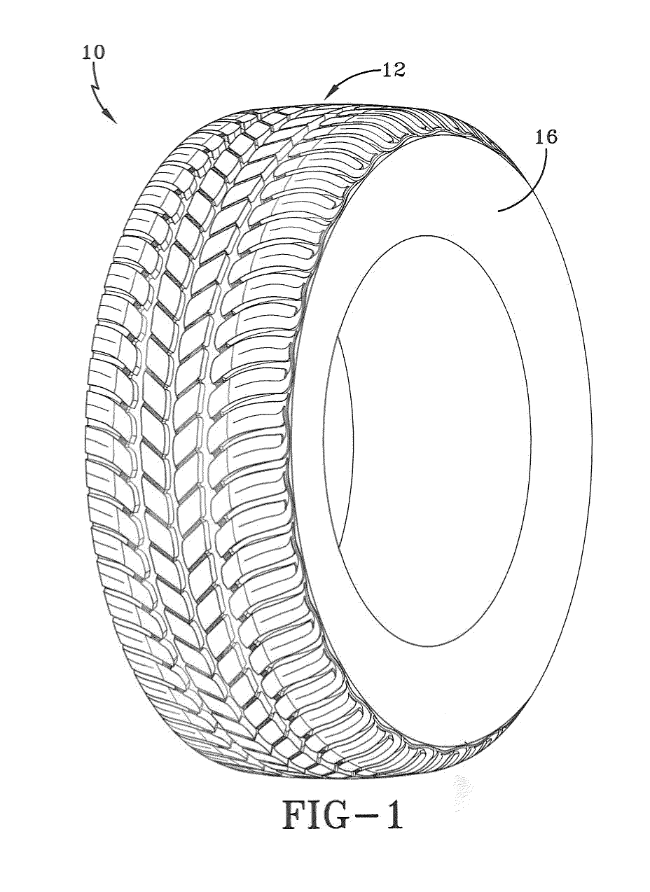

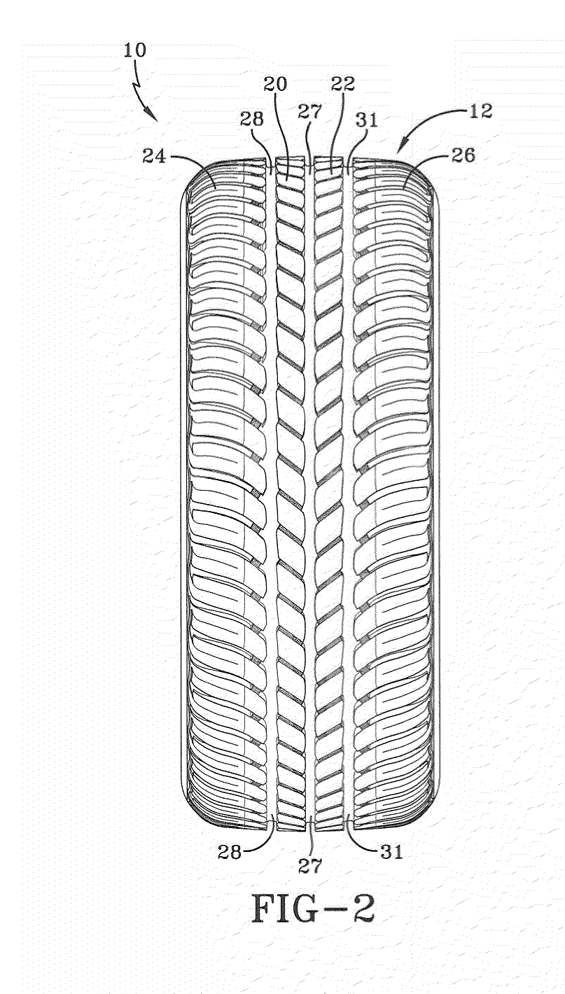

FIGS. 1-4 illustrate a first embodiment of a pneumatic tire, suitable for use as a passenger or truck tire, and particularly for use in wet conditions. The tire 10 has a tread 12 with a non-skid depth D. The tread 12 is designed to evolve as the tire wears to reveal hidden or sunken grooves as well as a second tread rubber composition so that the wet skid performance and aquaplaning performance does not degrade to unacceptable levels.

The tire 10 comprises a carcass which includes two sidewalls 16 which extend radially downward from the tread 12. The tire carcass further includes one or more radial plies (not shown) extending from and preferably wrapped about or otherwise secured to two annular beads (not shown). The tire may further optionally include an apex (not shown). The ply turnup in the bead area may be optionally reinforced with a chipper (not shown) wrapped about the bead ply. The tire 10 may further includes a liner as well as flippers and other tire components known to those skilled in the art.

### Tire Tread Dual Compound

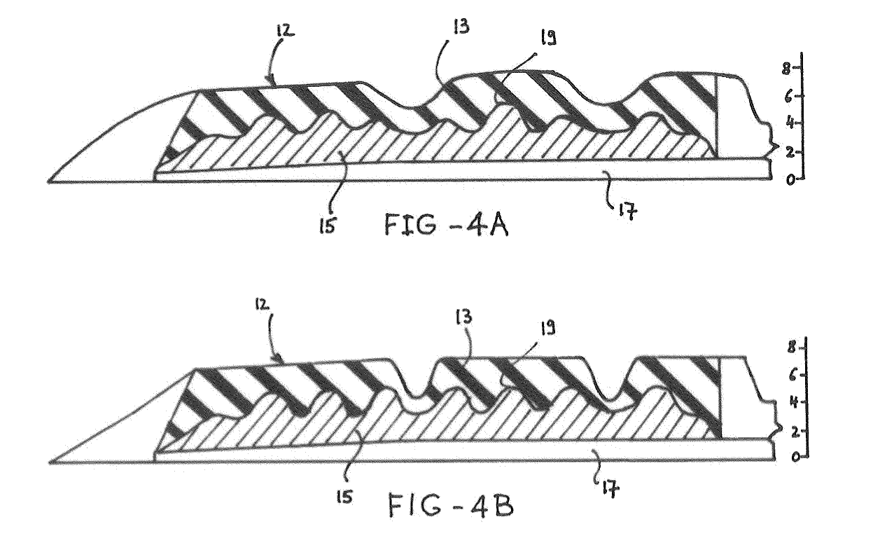

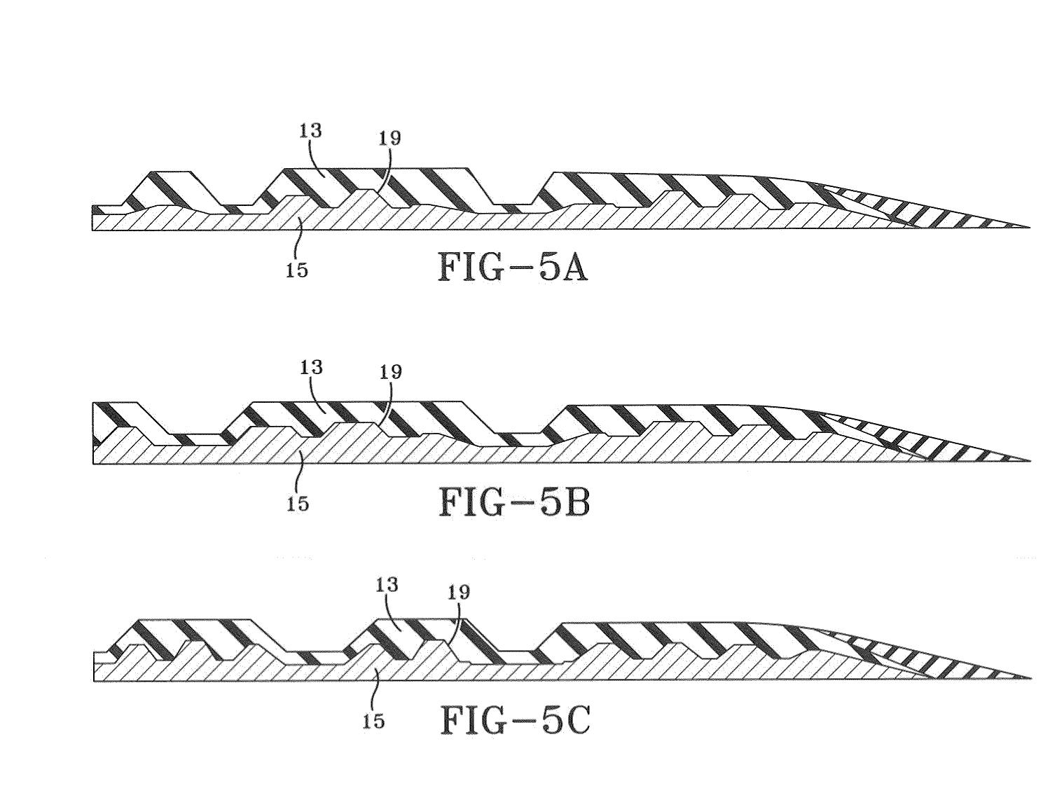

A cross-sectional view of the green tread layout is shown in FIG. 4a and FIGS. 5a-5c. FIG. 4b illustrates a cured tread. The tread 12 is comprised of dual layered tread cap rubber layer comprised of a combination of a radially outer tread cap layer 13 (or Cap 1) and a radially inner tread cap layer 15 (or cap 2) together with an underlying tread base rubber layer 17 which underlies the two-layers tread cap. As shown in the FIGS. 4a and 4b, the intersection 19 of the cap 1 layer and the cap 2 layer exhibits a wavy profile. In FIG. 4a, the separation 19 between the two tread cap layers is designed to account for the rubber flow around the molding elements. After curing, the intersection 19 between the cap 1 layer and the cap 2 layer (shown in FIG. 4.b) allows for a progressive exposure of the inner layer as the outer layers wears out. It is preferred that there be at least one peak located in each tread block or rib in the uncured or cured tread. Preferably there are two or more peaks in the uncured or cured tread. More preferably, there are at least three peaks in the uncured/cured tread between circumferential grooves. The wavy profile in the cured tread ensure that as the tread wears, the inner cap 2 layer 15 is exposed gradually so that there is not a large step change in compound properties. Preferably, the cap 2 layer 15 extends radially outwards of the tread circumferential groove bottoms, so that the cap 2 layer extends into the tread block or rib.

Alternatively, the cap 1 and cap 2 layer may be step shaped in the uncured or the cured tread, having a flat top.

The outer tread cap rubber layer 13 may be any desired tread compound, selected for example to promote low rolling resistance and good dry traction. The inner tread cap layer 15 is comprised of a rubber composition which promotes wet traction for the tread running surface as the outer tread cap layer wears away. This compound is progressively exposed during the wear-out of the outer compound to expose the softer inner tread cap layer. In one example for a summer tire, the tread caps may have the properties as described in the Table below. The tread caps may be co-extruded.

| | Tread cap 1 | Tread cap 2 | Difference in % |
|---|---|---|---|
| Mooney plasticity | 48 | 58 | 17 |
| RPA G′ 1% | 3.6 | 5.8 | 37 |
| Cold rebound | 24 | 17 | 43 |

### Tire Tread Rib and Sipe Layout

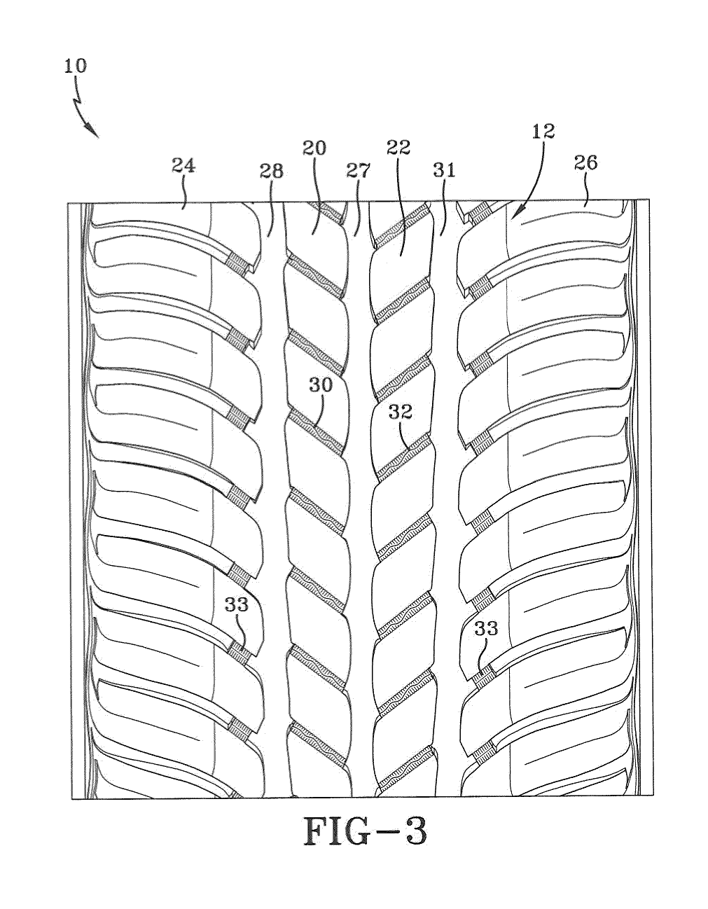

The tire tread 12 as shown in FIG. 3, is symmetrical about a circumferential plane or longitudinal axis. The tire tread 12 has at least one circumferentially aligned row of ribs 20, preferably two circumferentially aligned rows of ribs 20 and 22. The ribs 20, 22 are preferably circumferentially continuous and positioned adjacent the longitudinal axis. The tread 12 further comprises two circumferentially aligned rows of shoulder blocks 24 and 26. The width of the shoulder blocks is preferably greater than the inner ribs 20, 22, and ranges from 1.5 to 3.5 times the inner rib width. The shoulder blocks are separated by lateral grooves.

Positioned between ribs 20, 22 is a central circumferential groove 27, preferably continuous. The circumferential groove 27 is wide and positioned on the centerplane of the tire. A second circumferential groove 28 is positioned between shoulder block 24 and rib 20. A third circumferential groove 31 is positioned between rib 22 and shoulder block 26. Thus in this particular embodiment, there are three circumferential grooves 27, 28, 31. The outermost grooves 28, 31 are preferably slightly wider than center groove 27. The two center ribs 20, 22 have sipes 30, 32 angled with respect to the axial direction. The angles range from about 30 to about 50 degrees as measured from the tire's axial direction. More preferably, the angle of the sipes varies from about 40 to about 50 degrees. More preferably, the sipes have a wavy shape.

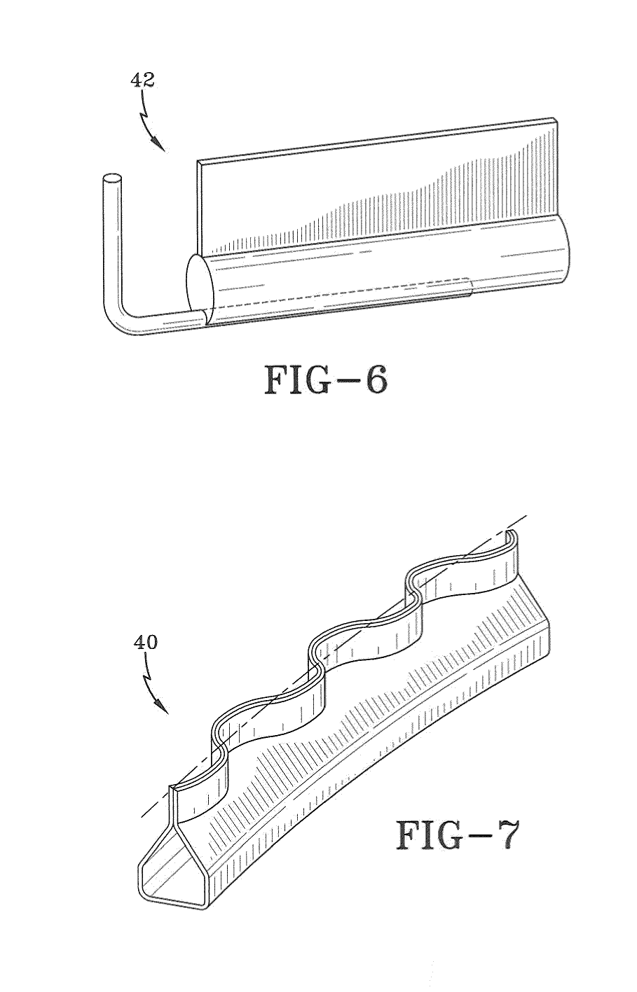

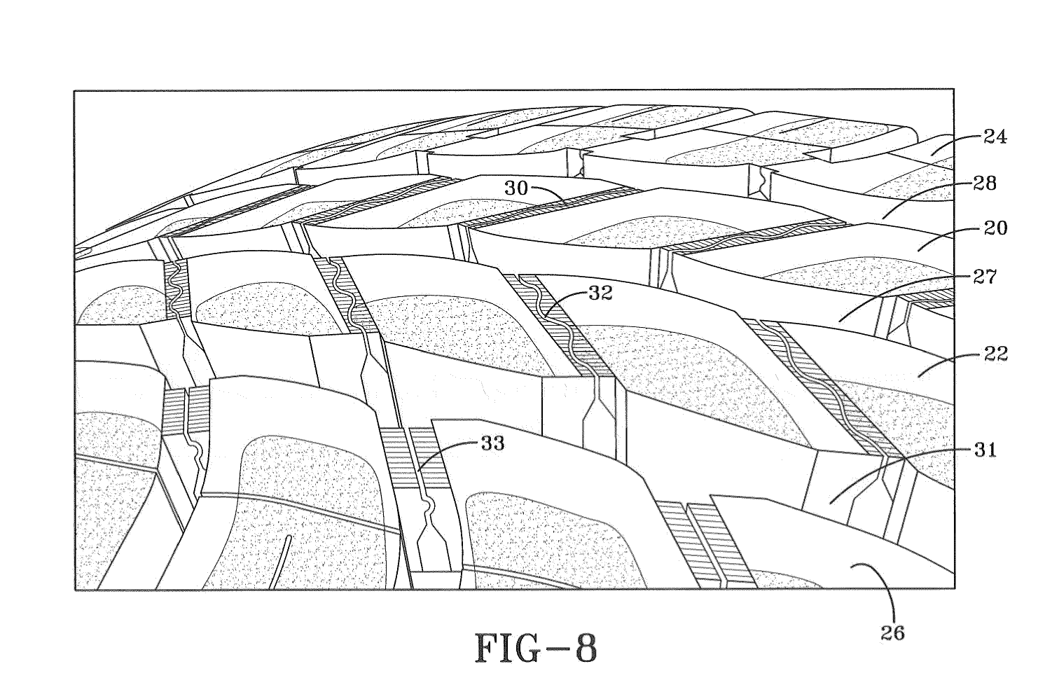

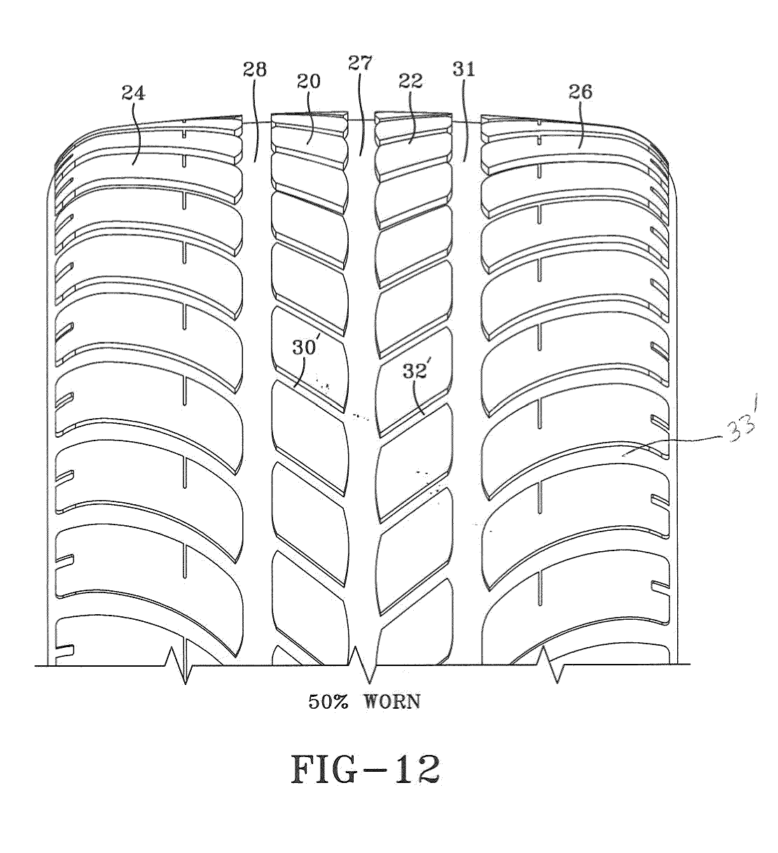

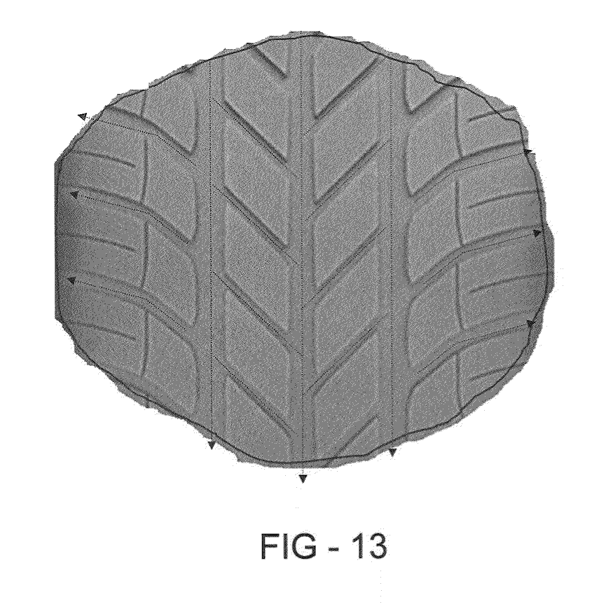

Preferably, sipes 30, 32 are formed by the blade 40 shown in FIG. 7. The sipes 30, 32 have a sunken groove 30′, 32′ disposed beneath the sipe and which is exposed to the tire tread surface as the tire tread is worn away during use. The sunk groove 30′, 32′ may be straight while the upper portion of the blade that forms the sipe is straight or wavy. Alternatively, sipes 30, 32 may be replaced with a sunken groove. The sipes and/or sunk groove are positioned such as the tread wears, the sunk grooves 30′, 32′ are gradually exposed. When exposed to the tread surface, the sunken grooves 30′, 32′ help channel water towards the circumferential grooves as shown in FIG. 13. The sipe/sunk groove combination may be formed by a key hole sipe blade 42 as shown in FIG. 6. When the sunk grooves are exposed to the tread surface, the ribs 20, 22 evolve into a circumferential row of tread blocks 20′, 22′. FIGS. 8-11 illustrate the tread with different levels of wear. The figures illustrate the sipe groove 30, 32 widening during wear, and eventually being replaced by a groove that connects the circumferential grooves 28, 27. FIG. 12 illustrates the tire appearance when the tread is worn.

The sunk grooves may be at varying depths, and may extend at a greater depth than the grooves between the tread blocks or ribs. The grooves may be sunk below the tread surface at a depth in the range of 30-110% of the nonskid depth. Preferably the sunk grooves extend into the cap 2 layer.

The tread shoulder blocks 24, 26 may additionally comprise sunk grooves formed by blades 40, or sipe blades 42 with a sunk groove beneath it. The sunk grooves when opened to the tread surface are positioned for communication with circumferential grooves 28, 31 to facilitate the channeling of water for hydroplaning resistance. The sipe/sunk groove combination may be formed by a key hole sipe blade 42 as shown in FIG. 6.

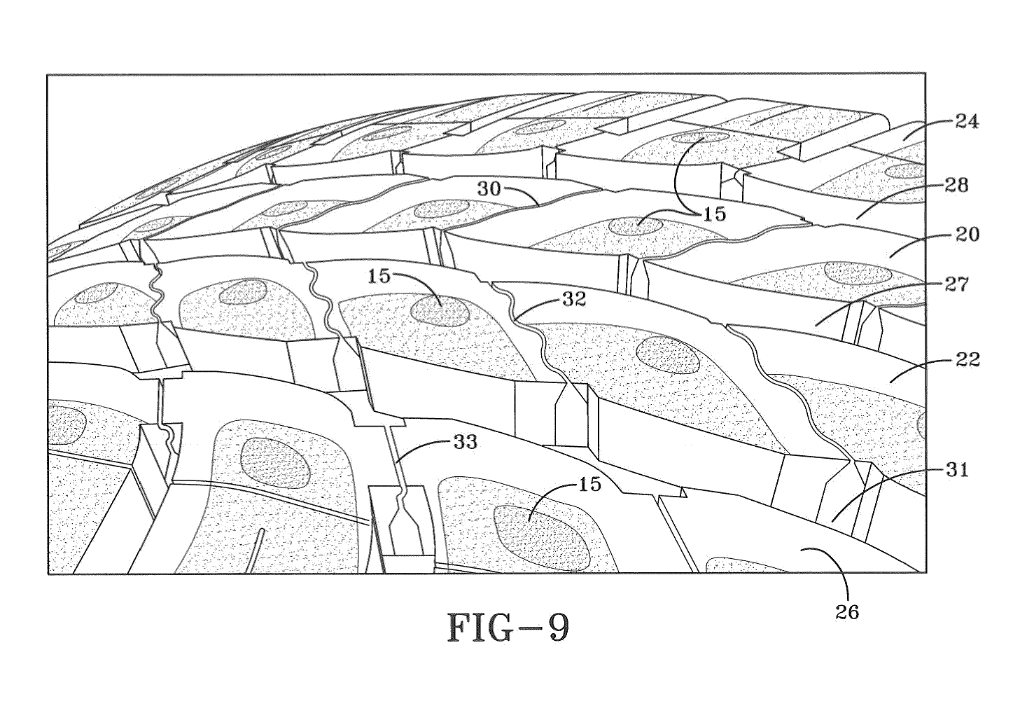

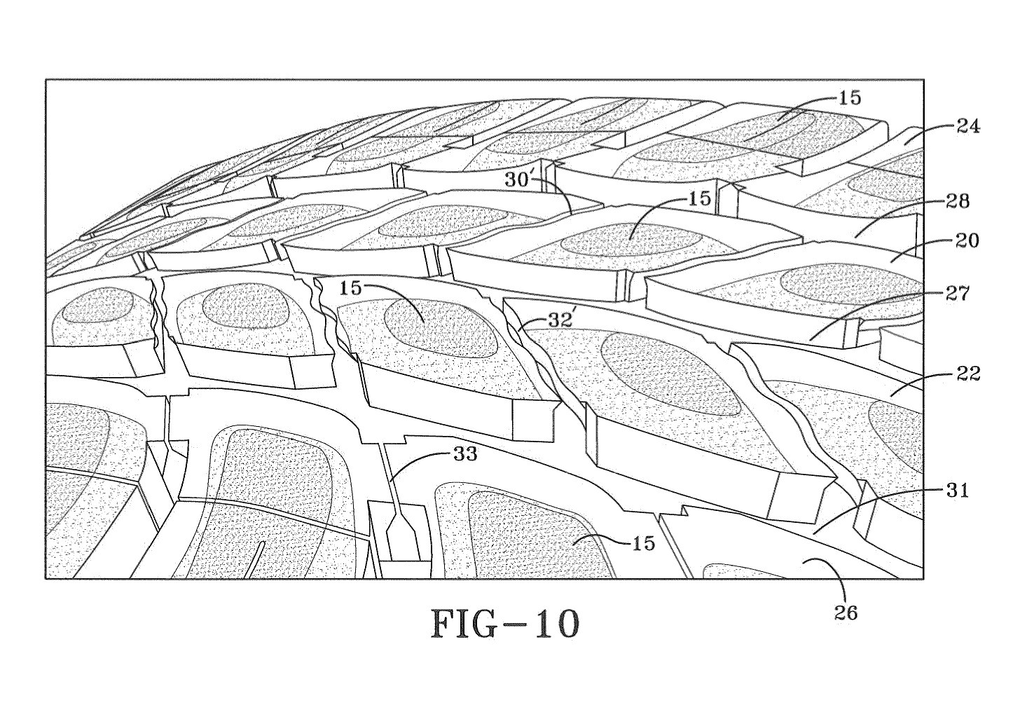

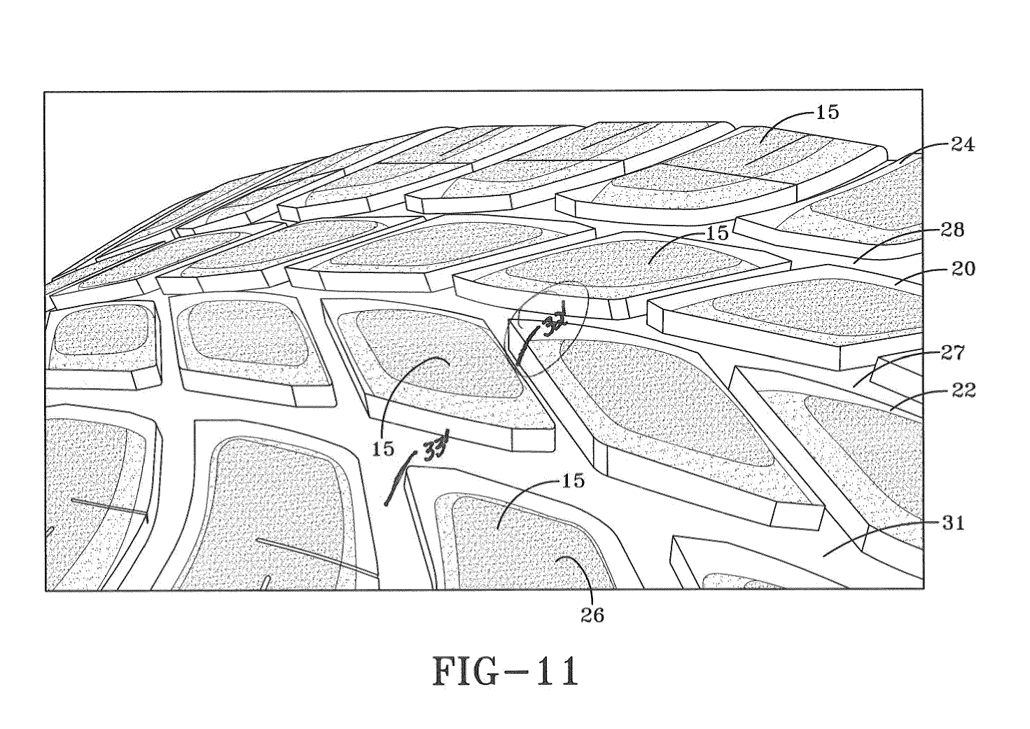

FIGS. 8-12 illustrate varying degrees of tread wear. FIG. 8 shows the tread surface in a new or unworn condition. FIG. 9 shows the tread surface in a slightly worn condition with sipes 30, 32, 33 still apparent. A small portion of the cap 2 layer has been exposed. FIG. 10 illustrates further wear of the tire tread. Sunken grooves 30′, 32′ have become exposed to the tread surface so that ribs 20, 22 have evolved into circumferentially aligned rows of blocks separated by grooves 30′, 32′. The exposed sunken grooves 30′, 32′ cooperate with circumferentially aligned grooves 27, 28, 31 to channel the water for improved wet traction. FIG. 10 also illustrates increased exposed area of the cap 2 layer having a tread compound selected for wet traction properties. FIGS. 11 and 12 illustrate even further tread wear wherein the lateral grooves in the shoulder are fully exposed and a higher amount of cap 2 layer is exposed.

FIG. 13 illustrates circumferential grooves 60, 62 in the shoulder blocks 24, 26 that are exposed upon wear.

The sunken grooves 30′, 32′, 33′ may be sunk below the tread surface at a depth in the range of 30-110% of the nonskid depth.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire having a tire tread, the tread comprising one or more grooves and one or more ground engaging tread elements, the tread having a radially outer surface and a non-skid tread depth as measured from the radially outer surface of the tread and a radially innermost surface of the grooves, and one or more sunken grooves located radially inward and below the surface of the unworn tread, the tread comprised of a base tread compound, a radially inner compound, and a radially outer compound wherein the radially outer compound is just below the surface of the tread.

2. The tire of claim 1 wherein the intersection of the radially inner compound and the radially outer compound is wavy.

3. The tire of claim 1 wherein the one or more sunken grooves are in fluid communication with the one or more circumferential grooves when the tread is in a worn condition.

4. The tire of claim 1 wherein the radially inner compound extends radially upwards into the tread elements.

5. The tire of claim 1 wherein the radially inner compound has higher hysteresis than the radially outer compound.

6. The tire of claim 1 wherein the radially inner compound has a cold rebound of about 17.

7. The tire of claim 1 wherein the radially inner compound has RPA G′ 1% of about 5.8.

8. The tire of claim 1 wherein the radially outer compound is selected for tread wear, and the radially inner compound is selected for wet traction.

9. The tire of claim 1 wherein the interface between the outer and inner compounds forms at least one peak located in a tread element.

10. The tire of claim 1 wherein the tread element is a rib.

11. The tire of claim 1 wherein the tread element is a tread block.

12. The tire of claim 1 wherein the surface of the tread comprises three circumferentially continuous grooves, wherein one of the grooves is located in the centerplane of the tire.

13. The tire of claim 1 wherein the surface of the tread comprises at least two circumferentially continuous ribs, wherein the ribs are located adjacent a circumferentially continuous groove.

14. A pneumatic tire having a tire tread, the tread comprising one or more circumferential grooves and one or more ground engaging tread elements, the tread having a radially outer surface and a non-skid tread depth as measured from the radially outer surface of the tread and a radially innermost surface of the grooves, and a sipe positioned on the surface of the tread and a sunken grooves located radially inward of the sipe and below the surface of the unworn tread, the tread comprised of a base tread compound, a radially inner compound, and a radially outer compound wherein the radially outer compound is just below the surface of the tread, wherein the intersection of the radially inner compound and the radially outer compound is wavy.
